(19) United States
(12) Patent Application Publication
(10) Pub. No.: US 2020/0171595 A1
(43) Pub. Date: Jun. 4, 2020

(54) METAL-CORED ELECTRODE FOR PRODUCING LOWER SLAG VOLUME WELDS

(71) Applicant: Hobart Brothers Company, Troy, OH (US)

(72) Inventors: Mario Amata, Dublin, OH (US); Steven E. Barhorst, Sidney, OH (US); Joseph C. Bundy, Piqua, OH (US); Susan R. Fiore, Dublin, OH (US)

(21) Appl. No.: 16/206,358

(22) Filed: Nov. 30, 2018

(51) Int. Cl. B23K 9/173; B23K 9/24

(52) U.S. Cl. CPC B23K 9/173; B23K 35/3612; B23K 9/24

(57) ABSTRACT

Utilizing a hydrogen compound source as an arc stabilizer is counter-intuitive to standard formulation design practices which often strive to limit or eliminate hydrogen from the welding arc and weld pool. The present disclosure is directed to a tubular metal-cored welding electrode that comprises a metallic sheath disposed around a granular metal core in which the granular metal core comprises an alginate arc stabilizer (as a hydrogen compound source) configured to release hydrogen near a surface of a workpiece during welding. The tubular metal-cored welding electrode may further comprise primary de-oxidizers such as manganese and silicon. In certain embodiments, the amount of manganese in the tubular metal-cored welding electrode may be minimized or eliminated. The tubular metal-cored welding electrode may also comprise nickel or titanium.

### FIELD

The present disclosure generally relates to a metal-cored (MC) electrode for producing a weld with a lower volume of slag, oxides, or silicates on the weld surface.

### BACKGROUND

The present disclosure relates generally to MC electrodes for welding, and in particular to MC electrodes for arc welding, such as Metal-Cored Arc Welding (MCAW).

Welding is a process that has become ubiquitous in various industries for a variety of applications. For example, welding is often used in applications such as shipbuilding, offshore platform, construction, pipe mills, and so forth. Certain welding techniques (e.g., Gas Metal Arc Welding (GMAW), Gas-shielded Flux Core Arc Welding (FCAW-G), and Gas Tungsten Arc Welding (GTAW)), typically employ a shielding gas (e.g., argon, carbon dioxide, or oxygen) to provide a particular local atmosphere in and around the welding arc and the weld pool during the welding process, while others (e.g., Flux Core Arc Welding (FCAW), Submerged Arc Welding (SAW), and Shielded Metal Arc Welding (SMAW)) do not. Additionally, certain types of welding may involve a welding electrode in the form of welding wire. Welding wire may generally provide a supply of filler metal for the weld as well as provide a path for the current during the welding process. Furthermore, certain types of welding wire (e.g., tubular welding wire) may include one or more components (e.g., flux, arc stabilizers, or other additives) that may generally alter the welding process or the properties of the resulting weld.

Primary de-oxidizers such as manganese and silicon are often considered necessary for de-oxidation of the MC arc weld pool. Formulations containing manganese and silicon will typically produce solid slag, oxides, and silicates on the surface of a weld. As such, antimony, bismuth, sulfur, or other surface active material is used to control the location of slag, oxides, and silicates.

Existing welding practices, particularly GMAW and MCAW, often strive to limit or eliminate hydrogen from the welding arc and weld pool. As such, hydrogen compound sources are typically limited or eliminated from welding wire compositions

There is a need for an improved MC electrode that does not generate slag, oxides, or silicates on a weld surface during welding, or to the extent that the MC electrode does generate slag oxides, or silicates during welding, the slag, oxides, and silicates are easily removed from the weld surface.

### SUMMARY

According to one aspect of the present disclosure, a tubular metal-cored welding electrode comprises a metallic sheath disposed around a granular metal core. The granular metal core comprises by weight of the tubular welding electrode: 0.05 to 5% of an alginate arc stabilizer configured to release hydrogen near a surface of a workpiece during welding, 0.1 to 1% silicon, and 0 to 2.5% manganese. In certain embodiments, the granular metal core may comprise by weight of the tubular welding electrode 0 to 0.25% manganese. In certain other embodiments, the granular metal core may comprise by weight of the tubular welding electrode 1 to 1.5% manganese. The granular metal core may further comprise by weight of the tubular welding electrode 0.5 to 1% nickel and 0.05 to 0.15% titanium. The alginate arc stabilizer may comprise potassium alginate (C₆H₇KO₆)ₙ, calcium alginate (C₁₂H₁₄CaO₁₂)ₙ, or sodium alginate (C₆H₇NaO₆)ₙ. The core may further comprise one or more metal hydrides and a Group I or Group II salt of carboxymethylcellulose (such as sodium carboxymethylcellulose (CMC), calcium CMC, or potassium CMC). The metallic sheath may comprise by weight of the tubular welding electrode: 0 to 0.025% carbon, 0.05 to 0.5% manganese (e.g., 0.2 to 0.3% manganese), and balance iron (along with any other additives and unavoidable impurities).

According to another aspect of the present disclosure, a method for forming a weld may comprise the steps of: providing a tubular welding electrode comprising a metallic sheath and a granular metal core; feeding the tubular welding electrode to a welding apparatus; feeding a shielding gas flow to the welding apparatus; providing a workpiece; bringing the welding apparatus near the workpiece to strike and sustain an arc between the tubular welding electrode and the workpiece; transferring a portion of the tubular welding electrode to the weld pool on the surface of the workpiece to form a weld bead on the weld deposit; and breaking down in the arc the alginate arc stabilizer to produce hydrogen, which combines with impurities and outgas instead of forming solid slag, oxides, or silicates on the weld surface. The tubular metal-cored welding electrode may have a composition as described in paragraph Error! Reference source not found above.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

The following is a description of the examples depicted in the accompanying drawings. The figures are not necessarily to scale, and certain features and certain views of the figures may be shown exaggerated in scale or in schematic in the interest of clarity or conciseness.

FIG. 1 is a block diagram of a metal-cored arc welding (MCAW) system, in accordance with embodiments of the present disclosure;

FIG. 2 is a cross-sectional view of a tubular welding wire, in accordance with embodiments of the present disclosure;

FIG. 3 is a process by which the tubular welding wire may be used to weld a workpiece, in accordance with embodiments of the present disclosure; and

FIG. 4 is a process for manufacturing the tubular welding wire, in accordance with embodiments of the present disclosure.

The foregoing summary, as well as the following detailed description, will be better understood when read in conjunction with the figures. It should be understood that the claims are not limited to the arrangements and instrumentality shown in the figures. Furthermore, the appearance shown in the figures is one of many ornamental appearances that can be employed to achieve the stated functions of the apparatus.

### DETAILED DESCRIPTION

In the following detailed description, specific details may be set forth in order to provide a thorough understanding of embodiments of the present disclosure. However, it will be clear to one skilled in the art when disclosed examples may be practiced without some or all of these specific details. For the sake of brevity, well-known features or processes may not be described in detail. In addition, like or identical reference numerals may be used to identify common or similar elements.

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. It should be appreciated that, as used herein, the term “tubular welding electrode” or “tubular welding wire” may refer to any welding wire or electrode having a metal sheath and a granular or powdered core, such as metal-cored or flux-cored welding electrodes. It should also be appreciated that the term “stabilizer” or “additive” may be generally used to refer to any component of the tubular welding that improves the quality of the arc, the quality of the weld, or otherwise affect the welding process. Furthermore, as used herein, “approximately” may generally refer to an approximate value that may, in certain embodiments, represent a difference (e.g., higher or lower) of less than 0.01%, less than 0.1%, or less than 1% from the actual value. That is, an “approximate” value may, in certain embodiments, be accurate to within (e.g., plus or minus) 0.01%, within 0.1%, or within 1% of the stated value.

As mentioned, certain types of welding electrodes (e.g., tubular welding wire) may include one or more components (e.g., flux, arc stabilizers, or other additives) that may generally alter the welding process and the properties of the resulting weld. For example, certain presently disclosed welding electrode embodiments include an alginate arc stabilizer (e.g., an alginate such as potassium alginate, calcium alginate, or sodium alginate) that may generally improve the stability of the arc while providing a reducing atmosphere conducive to welding coated workpieces (e.g., galvanized workpieces).

When this alginate breaks arc stabilizer down in the welding arc during welding it produces hydrogen. The hydrogen provides de-oxidation of the weld pool by combining with impurities that outgas instead of forming solid slag, oxides, or silicates on the weld surface. As such, the presently disclosed welding electrodes minimize the production of slag, oxides, or silicates on the weld surface with or without the inclusion of primary de-oxidizers such as manganese (Mn) and silicon (Si).

Further, the presently disclosed welding electrodes enhance the weldability of coated (e.g., galvanized, galvannealed, painted, and so forth) workpieces or thinner (e.g., 20-, 22-, 24-gauge, or thinner) workpieces, even at high travel speed (e.g., greater than 40 in/min). Additionally, the disclosed welding electrodes generally enable acceptable welds under different welding configurations (e.g., direct current electrode negative (DCEN), direct current electrode positive (DCEP), alternating currents (AC), and so forth) or different welding methods (e.g., involving circular or serpentine welding electrode movements during welding). Additionally, certain presently disclosed welding electrodes may be drawn to particular diameters (e.g., 0.030 in, 0.035 in, 0.040 in, or other suitable diameters) to provide good heat transfer and deposition rates.

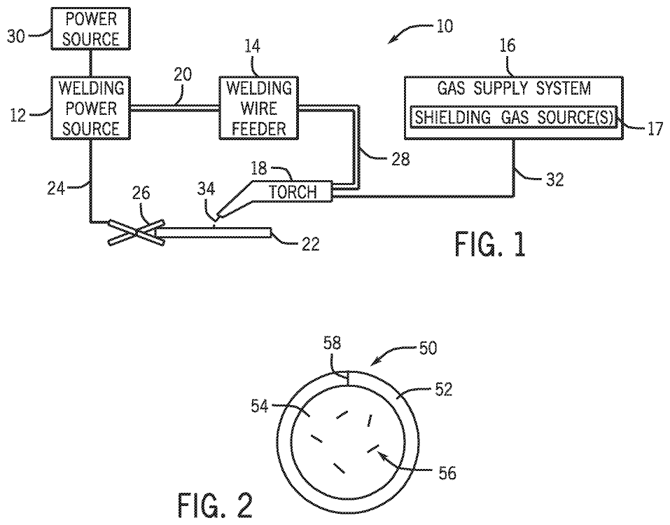

Turning to the figures, FIG. 1 illustrates an embodiment of a metal-cored arc welding (MCAW) system 10 that utilizes a welding electrode (e.g., tubular welding wire) in accordance with the present disclosure. The welding system 10 includes a welding power source 12, a welding wire feeder 14, a gas supply system 16, and a welding torch 18. The welding power source 12 generally supplies power to the welding system 10 and may be coupled to the welding wire feeder 14 via a cable bundle 20 as well as coupled to a workpiece 22 using a lead cable 24 having a clamp 26. In the illustrated embodiment, the welding wire feeder 14 is coupled to the welding torch 18 via a cable bundle 28 in order to supply consumable, tubular welding wire (i.e., the welding electrode) and power to the welding torch 18 during operation of the welding system 10. In another embodiment, the welding power unit 12 may couple and directly supply power to the welding torch 18.

The welding power source 12 may generally include power conversion circuitry that receives input power from an alternating current power source 30 (e.g., an AC power grid, an engine/generator set, or a combination thereof), conditions the input power, and provides DC or AC output power via the cable 20. As such, the welding power source 12 may power the welding wire feeder 14 that, in turn, powers the welding torch 18, in accordance with demands of the welding system 10. The lead cable 24 terminating in the clamp 26 couples the welding power source 12 to the workpiece 22 to close the circuit between the welding power source 12, the workpiece 22, and the welding torch 18. The welding power source 12 may include circuit elements (e.g., transformers, rectifiers, switches, and so forth) capable of converting the AC input power to a direct current electrode positive (DCEP) output, direct current electrode negative (DCEN) output, DC variable polarity, pulsed DC, or a variable balance (e.g., balanced or unbalanced) AC output, as dictated by the demands of the welding system 10. It should be appreciated that the presently disclosed welding electrodes (e.g., tubular welding wire) may enable improvements to the welding process (e.g., improved arc stability or improved weld quality) for a number of different power configurations.

The illustrated welding system 10 includes a gas supply system 16 that supplies a shielding gas or shielding gas mixtures from one or more shielding gas sources 17 to the welding torch 18. In the depicted embodiment, the gas supply system 16 is directly coupled to the welding torch 18 via a gas conduit 32. In another embodiment, the gas supply system 16 may instead be coupled to the wire feeder 14, and the wire feeder 14 may regulate the flow of gas from the gas supply system 16 to the welding torch 18. A shielding gas, as used herein, may refer to any gas or mixture of gases that may be provided to the arc or weld pool in order to provide a particular local atmosphere (e.g., to shield the arc, improve arc stability, limit the formation of metal oxides, improve wetting of the metal surfaces, alter the chemistry of the weld deposit, and so forth). In certain embodiments, the shielding gas flow may be a shielding gas or shielding gas mixture (e.g., argon (Ar), helium (He), carbon dioxide (CO₂), oxygen (O₂), nitrogen (N₂), similar suitable shielding gases, or any mixtures thereof). For example, a shielding gas flow (e.g., delivered via the conduit 32) may include CO₂, Ar, Ar/CO₂ mixtures, Ar/CO₂/O₂ mixtures, Ar/He mixtures, and so forth. By specific example, in certain embodiments, the shielding gas flow may include 100% CO₂. A shielding gas flow of pure CO₂ may be effective for the presently disclosed welding wire compositions. In other embodiments, the shielding gas flow may include 75-95% Ar and 5-25% CO₂ (e.g., 90% Ar and 10% CO₂) or pure Ar.

Accordingly, the illustrated welding torch 18 generally receives the welding electrode (i.e., the tubular welding wire), power from the welding wire feeder 14, and a shielding gas flow from the gas supply system 16 in order to perform MCAW of the workpiece 22. During operation, the welding torch 18 may be brought near the workpiece 22 so that an arc 34 may be formed between the consumable welding electrode (i.e., the welding wire exiting a contact tip of the welding torch 18) and the workpiece 22. Additionally, as discussed below, by controlling the composition of the welding electrode (i.e., the tubular welding wire), the chemistry of the arc 34 or the resulting weld (e.g., composition and physical characteristics) may be varied. For example, the welding electrode may include fluxing or alloying components that may affect the welding process (e.g., act as arc stabilizers) and, further, may become at least partially incorporated into the weld, affecting the mechanical properties of the weld. Furthermore, certain components of the welding electrode (i.e., welding wire) may also provide additional shielding atmosphere near the arc, affect the transfer properties of the arc 34, deoxidize the surface of the workpiece, and so forth.

A cross-section of an embodiment of the presently disclosed welding wire is illustrated in FIG. 2. FIG. 2 illustrates a tubular welding wire 50 that includes a metallic sheath 52, which encapsulates a granular or powdered metal core 54 (also referred to as filler). In certain embodiments, the tubular welding wire 50 may comply with one or more American Welding Society (AWS) standards. For example, in certain embodiments, the tubular welding wire 50 may be in accordance with AWS A5.18 (“SPECIFICATION FOR CARBON STEEL ELECTRODES AND RODS FOR GAS SHIELDED ARC WELDING”) or with AWS A5.36 (“SPECIFICATION FOR CARBON AND LOW-ALLOY STEEL FLUX CORED ELECTRODES FOR FLUX CORED ARC WELDING AND METAL CORED ELECTRODES FOR GAS METAL ARC WELDING”).

The metallic sheath 52 of the tubular welding wire 50 illustrated in FIG. 2 may be manufactured from any suitable metal or alloy, such as steel. It should be appreciated that the composition of the metallic sheath 52 may affect the composition of the resulting weld or the properties of the arc 34. In certain embodiments, the metallic sheath 52 may account for between approximately 70% to 95% of the total weight of the tubular welding wire 50. For example, in certain embodiments, the metallic sheath 52 may provide approximately 80% to 90%, or approximately 84% to approximately 86%, or approximately 85%, of the total weight of the tubular welding wire 50. As such, in certain embodiments, the granular metal core 54 may account for between approximately 5% to 30% (or approximately 10% to 20%, or approximately 14% to 16%, or approximately 15%) of the total weight of the tubular welding wire 50.

In the present disclosure, amounts of elements or compounds within the granular metal core 54 may be provided by weight of the tubular welding electrode 50. It should be appreciated that such amounts will be greater when calculated by weight of the granular metal core 54 itself, because the granular metal core 54 forms a fraction (for example, 5% to 30%) of the tubular welding wire 50. Similarly, amounts of elements or compounds within the metallic sheath 52 may also be provided by weight of the tubular welding electrode 50. Thus, similarly, it should be appreciated that such amounts will be greater when calculated by weight of the metallic sheath 52 itself, because the metallic sheath 52 forms a fraction (for example, 70% to 95%) of the tubular welding wire 50.

As such, the metallic sheath 52 may include certain additives or impurities (e.g., alloying components, carbon, alkali metals, manganese, or similar compounds or elements) that may be selected to provide desired weld properties. In certain embodiments, the metallic sheath 52 of the tubular welding wire 50 may be a low-carbon strip that includes a relatively small (e.g., lower or reduced) amount of carbon (e.g., less than approximately 0.06%, less than approximately 0.07%, or less than approximately 0.08% carbon by weight). For example, in an embodiment, the metallic sheath 52 of the tubular welding wire 50 may include between approximately 0.07% and 0.1% carbon by weight (e.g., approximately 0.08% carbon by weight). In another embodiment, the metallic sheath 52 of the tubular welding wire 50 may include between approximately 0.02% and 0.04% carbon by weight (e.g., approximately 0.03% carbon by weight). Additionally, in certain embodiments, the metallic sheath 52 may be made of steel generally having a small number of inclusions. For example, in certain embodiments, the metallic sheath 52 may include between approximately 0.05% and approximately 0.4%, or between approximately 0.2% and 0.3%, or approximately 0.25% manganese by weight. By further example, in certain embodiments, the metallic sheath 52 may include less than approximately 0.02% phosphorus or sulfur by weight. The metallic sheath 52, in certain embodiments, may also include less than approximately 0.04% silicon by weight, less than approximately 0.05% aluminum by weight, less than approximately 0.1% copper by weight, or less than approximately 0.02% tin by weight. The metallic sheath 52 may contain balance iron. For example, in certain embodiments, the metallic sheath may contain 79-81% iron or 84-86% iron by total weight of the tubular welding wire 50.

The granular metal core 54 of the illustrated tubular welding wire 50 may generally be a compacted metal powder. In certain embodiments, the granular metal core 54 may account for between approximately 7% and approximately 40%, or between approximately 10% and approximately 20%, of the total weight of the tubular welding wire 50. For example, in certain embodiments, the granular metal core 54 may provide approximately 14%, approximately 15%, or approximately 16% of the total weight of the tubular welding wire 50. Furthermore, in certain embodiments, the components of the granular metal core 54, discussed below, may be homogenously or non-homogenously (e.g., in clumps or clusters 56) disposed within the granular metal core 54. For example, the granular metal core 54 of certain welding electrode embodiments (e.g., metal-cored welding electrodes) may include one or more metals (e.g., iron, iron titanium, iron silicon, or other alloys or metals) that may provide at least a portion of the filler metal for the weld.

By specific example, in certain embodiments, the granular metal core 54 may include between approximately 70% and approximately 75% iron powder, as well as other alloying components, such as ferro-titanium (e.g., 40% grade), ferro-magnesium-silicon, and ferro-silicon powder (e.g., 50% grade, unstabilized). In certain embodiments, the granular metal core 54 may include between approximately 0.1 and approximately 1% silicon, or between approximately 0.2 and approximately 0.9% silicon, or between approximately 0.4 and 0.8% silicon, or approximately 0.65% silicon. In certain “manganese controlled” embodiments, the granular metal core 54 may include between 0 and approximately 0.25% manganese, or between approximately 0.01 and approximately 0.1% manganese, or between approximately 0.02 and 0.08% manganese, or approximately 0.05% manganese. In certain (not “manganese controlled”) embodiments, the granular metal core 54 may include between approximately 0.5 and approximately 2% manganese, or between approximately 1 and approximately 1.5% manganese, or between approximately 1.1 and 1.3% manganese, or approximately 1.2% manganese. In certain embodiments, the granular metal core 54 may include between approximately 0.01 and approximately 0.2% titanium, or between approximately 0.05 and 0.1% titanium, or approximately 0.095% titanium. In certain embodiments, the granular metal core 54 may include between approximately 0.01 and approximately 0.1% antimony trioxide (Sb₂O₃), or between approximately 0.02 and 0.04% antimony trioxide, or approximately 0.035% antimony trioxide. In certain embodiments, the granular metal core 54 may include between approximately 0.001 and approximately 0.1% potassium oxide (K₂O), or between approximately 0.01 and 0.05% potassium oxide, or approximately 0.02% potassium oxide. In certain embodiments, the granular metal core 54 may include between approximately 0.005 and approximately 0.05% bismuth trioxide (Bi₂O₃), or between approximately 0.01 and 0.02% bismuth trioxide, or approximately 0.015% bismuth trioxide. In certain embodiments, for example in “manganese controlled” embodiments, the granular metal core 54 may include between approximately 0.1 and approximately 2% nickel, or between approximately 0.5 and 1% nickel, or approximately 0.75% nickel. In certain embodiments, for example in “manganese controlled” embodiments, the granular metal core 54 may include between approximately 0.1 and approximately 5% copper, or between approximately 0.15 and 0.2% copper, or approximately 0.17% copper. In certain embodiments, for example in “manganese controlled” embodiments, the granular metal core 54 may include between approximately 0.01 and approximately 0.1% magnesium, or between approximately 0.05 and 0.08% magnesium, or approximately 0.07% magnesium. Other examples of components that may be present within the tubular welding wire 50 (i.e., in addition to the one or more carbon sources and the one or more alkali metal or alkali earth metal compounds) include other stabilizing, fluxing, and alloying components, such as may be found in METALLOY X-CEL™ welding electrodes available from Illinois Tool Works, Inc.

Additionally, presently disclosed embodiments of the tubular welding wire 50 may include an alginate arc stabilizer disposed in the granular metal core 54. The alginate arc stabilizer may be potassium alginate, calcium alginate, or sodium alginate. Alternatively, other alginates may be used, including lithium alginate, barium alginate, or magnesium alginate. In certain embodiments, the alginate arc stabilizer may account for less than approximately 10%, between approximately 0.05% and approximately 5%, between approximately 0.1% and approximately 3%, between approximately 0.25% and approximately 2.5%, between approximately 0.5% and approximately 1.5%, or approximately 1% of the granular metal core 54 by weight. Additionally, in certain embodiments, the alginate arc stabilizer may account for less than approximately 5%, between approximately 0.05% and approximately 3%, between approximately 0.08% and approximately 2%, between approximately 0.1% and approximately 1%, or approximately 0.15% of the tubular welding wire 50 by weight.

When the alginate arc stabilizer breaks down in the welding arc, it produces hydrogen. The hydrogen provides de-oxidation of the weld pool by combining with impurities that outgas instead of forming solid slag, oxides, or silicates on the weld surface. By using an alginate for de-oxidation it is possible to reduce the components that oxidize to form solid oxides/slag. Thus, using an alginate for de-oxidation allows for the amount of silicon and manganese in the weld metal to be reduced, minimized, or potentially eliminated. For example, according to certain presently disclosed embodiments, the tubular welding wire 50 may comprise a metallic sheath 52 that contains no silicon or manganese (except for unavoidable impurities). Similarly, according to certain presently disclosed embodiments, the tubular welding wire 50 may comprise a granular metal core 52 that contains no silicon or manganese (except for unavoidable impurities, e.g. in iron powder in the granular metal core 52). Further, because the amount of solid oxides/silicates on the weld bead surface is reduced, it is possible to minimize or eliminate slag/oxide/silicate control additives such as sulfur and antimony that may compromise crack resistance. Further still, tougher weld metal may be attained because the amount of ferrite stabilizers used for de-oxidation may be reduced.

The alginate arc stabilizer component of the tubular welding wire 50 may be maintained at a suitable level such that a reducing environment (e.g., hydrogen-rich) may be provided near the welding arc, but without introducing substantial porosity into the weld. Utilizing a hydrogen compound source as an arc stabilizer is counter-intuitive to standard formulation design practices which often strive to limit or eliminate hydrogen from the welding arc and weld pool. Hydrogen and carbon liberated near the weld pool and into the weld pool can capture oxygen that has dissolved into the weld. The oxygen is usually reacted/captured by using silicon or manganese (or both). An advantage to using a hydrogen compound source as an arc stabilizer is that carbon oxides and hydrogen oxides are gaseous and do not form added slag on the surface of the weld bead (in contrast to silicon oxide and manganese oxide, which are both solid and form slag on the weld bead).

Using potassium alginate as the alginate arc stabilizer may lead to additional benefits. For example, the potassium liberated under the arc helps to form plasma that conducts current through the arc avoiding turbulence that can cause a high degree of metal spatter. In addition, potassium oxide from the alginate that enters and forms part of the slag forms oxide compounds that have lower melting temperatures (thus increasing the temperature gap between the weld solidifying and the slag solidifying), which makes the slag more poorly bonded to the surface of the bead, hence more easily detached and removed.

Due to improved arc stability, an alginate such as potassium alginate can be used in designs intended to be welded with carbon dioxide shielding gas (100% CO₂). Carbon dioxide shielding in situations where the arc is not stabilized tends to result in current noise and high weld spatter. Further, Because the arc stability and de-oxidation capability and enhanced slag detachment, potassium alginate as the alginate arc stabilizer is ideal for use in “manganese controlled” wire formulations, such as the Hobart Element FabCOR wire formulations. These wire formulations have minimal or no manganese added in the granular metal core. Because of its de-oxidation capability, improved arc stability and slag detachability, potassium alginate as the alginate arc stabilizer can be very useful and quickly implemented in traditional designs to lower the weld spatter and improve weld cleaning prior to painting.

Using an alginate such as potassium alginate as the alginate arc stabilizer may lead to an increase in how much hydrogen the weld metal contains. This may cause hydrogen impairment on weld metal ductility until the hydrogen diffuses out. Further, an increased hydrogen content may increase the risk for delayed cracking.

Additionally, presently disclosed embodiments of the tubular welding wire 50 may also include a carbon component disposed in the granular metal core 54. For example, the carbon source present in the granular metal core 54 or the metal sheath 52 may be in a number of forms and may stabilize the arc 34 or increase the carbon content of the weld. For example, in certain embodiments, graphite, graphene, nanotubes, fullerenes or similar substantially sp²-hybridized carbon sources may be utilized as the carbon source in the tubular welding wire 50. Furthermore, in certain embodiments, graphene or graphite may be used to also provide other components (e.g., moisture, gases, metals, and so forth) that may be present in the interstitial space between the sheets of carbon. In other embodiments, substantially sp³-hybridized carbon sources (e.g., micro- or nano-diamond, carbon nanotubes, buckyballs) may be used as the carbon source. In still other embodiments, substantially amorphous carbon (e.g., carbon black, lamp black, soot, or similar amorphous carbon sources) may be used as the carbon source. Furthermore, while the present disclosure may refer to this component as a “carbon source,” it should be appreciated that the carbon source may be a chemically modified carbon source that may contain elements other than carbon (e.g., oxygen, halogens, metals, and so forth). For example, in certain embodiments, the tubular welding wire 50 may include a carbon black component in the granular metal core 54 that may contain a manganese content of approximately 20%. In certain embodiments, the carbon component of the tubular welding wire 50 may be powdered or granular graphite. Additionally, in certain embodiments, the carbon component may account for less than approximately 10%, between approximately 0.01% and approximately 5%, between approximately 0.05% and approximately 2.5%, between approximately 0.1% and approximately 1%, or approximately 0.5% of the granular metal core 54 by weight. In certain embodiments, the carbon component may account for less than approximately 5%, between approximately 0.01% and approximately 2.5%, between approximately 0.05% and approximately 0.1%, or approximately 0.08% of the tubular welding wire 50 by weight.

Furthermore, in addition to the alginate arc stabilizer discussed above, the tubular welding wire 50 may also include one or more other arc stabilizers to further stabilize the arc 34. For example, the granular metal core 54 of the tubular welding wire 50 may include one or more compounds of the Group 1 and Group 2 elements (e.g., Li, Na, K, Rb, Cs, Be, Mg, Ca, Sr, Ba), or other arc stabilizing compounds.

The tubular welding wire 50 may contain additional additives, including hydrogen-containing compounds (hydrogen sources). For example, the granular metal core 54 may include additional hydrogen-containing compounds such as: metal hydrides, a Group I or Group II salt of carboxymethylcellulose (e.g., sodium carboxymethylcellulose (CMC), calcium CMC or potassium CMC), or anthracene (C₁₄H₁₀). A non-limiting list of other compounds that may be added to the tubular welding wire 50 include: Group 1 (i.e., alkali metal) and Group 2 (i.e., alkaline earth metal) silicates, titanates, carbonates, halides, phosphates, sulfides, hydroxides, oxides, permanganates, silicohalides, feldspars, pollucites, molybdenites, and molybdates. For example, in an embodiment, the granular metal core 54 of the tubular welding wire 50 may include potassium manganese titanate, potassium sulfate, sodium feldspar, potassium feldspar, or lithium carbonate. By specific example, the granular metal core 54 may include potassium silicate, potassium titanate, potassium carbonate, potassium fluoride, potassium phosphate, potassium sulfide, potassium hydroxide, potassium oxide, potassium permanganate, potassium silicofluoride, potassium feldspar, potassium molybdates, or a combination thereof as the potassium source. Similar examples of stabilizing compounds that may be used are described in U.S. Pat. No. 7,087,860, entitled “STRAIGHT POLARITY METAL CORED WIRES,” and U.S. Pat. No. 6,723,954, entitled “STRAIGHT POLARITY METAL CORED WIRE,” which are both incorporated by reference in their entireties for all purposes.

Furthermore, for certain embodiments of the presently disclosed tubular welding wire 50, one or more other arc stabilizers may be included in the granular metal core 54 in the form of an agglomerate or frit. That is, certain embodiments of the tubular welding wire 50 may include one or more of the other arc stabilizers described above in an agglomerate or frit that may stabilize the arc during welding. The term “agglomerate” or “frit,” as used herein, refers to a mixture of compounds that have been fired or heated in a calciner or oven such that the components of the mixture are in intimate contact with one another. It should be appreciated that the agglomerate may have subtly or substantially different chemical or physical properties than the individual components of the mixture used to form the agglomerate. For example, agglomerating, as presently disclosed, may provide a frit that is better suited for the weld environment than the non-agglomerated materials.

In certain embodiments, the granular metal core 54 of the tubular welding wire 50 may include an agglomerate of one or more alkali metal or alkaline earth metal compounds (e.g., potassium oxide, sodium oxide, calcium oxide, magnesium oxide, or other suitable alkali metal or alkaline earth metal compound). In other embodiments, the granular metal core 54 of the tubular welding wire 50 may include an agglomerate of a mixture of alkali metal or alkaline earth metal compound and other oxides (e.g., silicon dioxide, titanium dioxide, manganese dioxide, or other suitable metal oxides). For example, one embodiment of a tubular welding wire 50 may include an agglomerated potassium source including of a mixture of potassium oxide, silica, and titania. By further example, another embodiment of a tubular welding wire 50 may include in the granular metal core 54 another stabilizing agglomerate having a mixture of potassium oxide (e.g., between approximately 22% and 25% by weight), silicon oxide (e.g., between approximately 10% and 18% by weight), titanium dioxide (e.g., between approximately 38% and 42% by weight), and manganese oxide or manganese dioxide (e.g., between approximately 16% and 22% by weight). In certain embodiments, an agglomerate may include between approximately 5% and 75% alkali metal or alkaline earth metal compound (e.g., potassium oxide, calcium oxide, magnesium oxide, or other suitable alkali metal or alkaline earth metal compound) by weight, or between approximately 5% and 95% alkali metal or alkaline earth metal (e.g., potassium, sodium, calcium, magnesium, or other suitable alkali metal or alkaline earth metal) by weight. Furthermore, in certain embodiments, other chemical or physical factors (e.g., maximizing alkali metal or alkaline earth metal loading, acidity, stability, or hygroscopicity of the agglomerate) may be considered when selecting the relative amounts of each component present in the agglomerate mixture. Additionally, in certain embodiments, the agglomerate may account for less than approximately 10%, between approximately 0.1% and approximately 6%, between approximately 0.25% and approximately 2.5%, between approximately 0.5% and approximately 1.5%, or approximately 1% of the granular metal core 54 by weight. In certain embodiments, the agglomerate may account for less than approximately 5%, between approximately 0.05% and approximately 2.5%, between approximately 0.1% and approximately 0.5%, or approximately 0.15% of the tubular welding wire 50 by weight.

Additionally, the granular metal core 54 of the tubular welding wire 50 may also include other components to control the welding process. For example, rare earth elements may generally affect the stability and heat transfer characteristics of the arc 34. As such, in certain embodiments, the tubular welding wire 50 may include a rare earth component, such as the Rare Earth Silicide (e.g., available from Miller and Company of Rosemont, Ill.), which may include rare earth elements (e.g., cerium and lanthanum) and other non-rare earth elements (e.g., iron and silicon). In other embodiments, any material including cerium or lanthanum (e.g., nickel lanthanum alloys) may be used in an amount that does not spoil the effect of the present approach. By specific example, in certain embodiments, the rare earth component may account for less than approximately 10%, between approximately 0.01% and approximately 8%, between approximately 0.5% and approximately 5%, between approximately 0.25% and approximately 4%, between approximately 1% and approximately 3%, between approximately 0.75% and approximately 2.5%, or approximately 2% of the granular metal core 54 by weight. In certain embodiments, the rare earth component may account for less than approximately 5%, between approximately 0.01% and approximately 2.5%, between approximately 0.1% and approximately 0.75%, or approximately 0.3% of the tubular welding wire 50 by weight.

Furthermore, the tubular welding wire 50 may, additionally or alternatively, include other elements or minerals to provide arc stability and to control the chemistry of the resulting weld. For example, in certain embodiments, the granular metal core 54 or the metallic sheath 52 of the tubular welding wire 50 may include certain elements (e.g., titanium, manganese, zirconium, fluorine, or other elements) or minerals (e.g., pyrite, magnetite, and so forth). By specific example, certain embodiments may include zirconium silicide, nickel zirconium, or alloys of titanium, aluminum, or zirconium in the granular metal core 54. In particular, sulfur containing compounds, including various sulfide, sulfate, or sulfite compounds (e.g., such as molybdenum disulfide, iron sulfide, manganese sulfite, barium sulfate, calcium sulfate, or potassium sulfate) or sulfur-containing compounds or minerals (e.g., pyrite, gypsum, or similar sulfur-containing species) may be included in the granular metal core 54 to improve the quality of the resulting weld by improving bead shape and facilitating slag detachment, which may be especially useful when welding galvanized workpieces, as discussed below. Furthermore, in certain embodiments, the granular metal core 54 of the tubular welding wire 50 may include multiple sulfur sources (e.g., manganese sulfite, barium sulfate, and pyrite), while other embodiments of the tubular welding wire 50 may include only a single sulfur source (e.g., potassium sulfate) without including a substantial amount of another sulfur source (e.g., pyrite or iron sulfide). For example, in an embodiment, the granular metal core 54 of the tubular welding wire 50 may include between approximately 0.01% and approximately 0.5%, or approximately 0.2% potassium sulfate.

Generally speaking, the tubular welding wire 50 may generally stabilize the formation of the arc 34 to the workpiece 22. As such, the disclosed tubular welding wire 50 may improve more than one aspect of the welding process (e.g., deposition rate, travel speed, splatter, bead shape, weld quality, etc.). It should further be appreciated that the improved stability of the arc 34 may generally enable and improve the welding of coated metal workpieces and thinner workpieces. For example, in certain embodiments, the coated metal workpieces may include galvanized, galvannealed (e.g., a combination of galvanization and annealing), or similar zinc-coated workpieces. A non-limiting list of example coated workpieces further includes dipped, plated (e.g., nickel-plated, copper-plated, tin-plated, or electroplated or chemically plated using a similar metal), chromed, nitrite-coated, aluminized, or carburized workpieces. For example, in the case of galvanized workpieces, the presently disclosed tubular welding wire 50 may generally improve the stability and control the penetration of the arc 34 such that a good weld may be achieved despite the zinc coating on the outside of the workpiece 22. Additionally, by improving the stability of the arc 34, the disclosed tubular welding wire 50 may generally enable the welding of thinner workpieces than may be possible using other welding electrodes. For example, in certain embodiments, the disclosed tubular welding wire 50 may be used to weld metal having an approximately 14-, 16-, 18-, 20-, 22-, 24-gauge, or even thinner workpieces. For example, in certain embodiments, the disclosed tubular welding wire 50 may enable welding workpieces having a thickness less than approximately 5 mm, less than 3 mm, or even less than approximately 1.5 mm.

Furthermore, the presently disclosed tubular welding wire 50 enables welding (e.g., welding of thin gauge galvanized steels) at travel speeds in excess of 30 or even 40 inches per minute. For example, the tubular welding wire 50 readily enables high quality fillet welds at travel speeds above 40 inches per minute (e.g., 35 or 45 inches per minute) with low weld porosity. That is, the presently disclosed tubular welding wire 50 may enable higher (e.g., 50% to 75% higher) travel speeds than other solid-cored, metal-cored, or flux-cored welding wires. It should be appreciated that higher travel speeds may enable higher production rates (e.g., on a production line) and reduce costs. Additionally, the presently disclosed tubular welding wire 50 exhibits good gap handling and provides excellent weld properties (e.g., strength, ductility, appearance, and so forth) using a wide operating process window. Further, the tubular welding wire 50 generally produces less smoke and spatter than other solid-cored, metal-cored, or flux-cored welding wires.

Furthermore, the disclosed tubular welding wire 50 may also be combined with certain welding methods or techniques (e.g., techniques in which the welding electrode moves in a particular manner during the weld operation) that may further increase the robustness of the welding system 10 for particular types of workpieces. For example, in certain embodiments, the welding torch 18 may be configured to cyclically or periodically move the electrode in a desired pattern (e.g., a circular, spin arc, or serpentine pattern) within the welding torch 18 in order to maintain an arc 34 between the tubular welding wire 50 and the workpiece 22 (e.g., only between the sheath 52 of the tubular welding wire 50 and the workpiece 22).

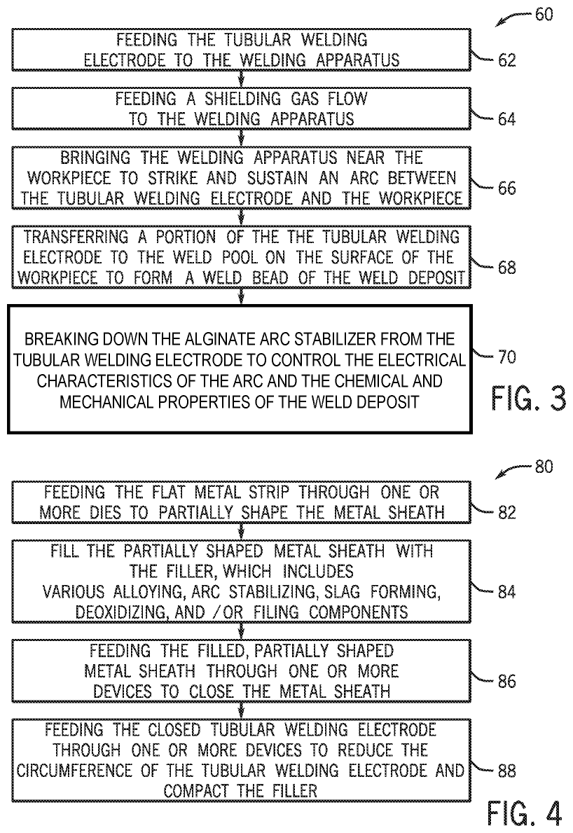

FIG. 3 illustrates an embodiment of a process 60 by which a workpiece 22 may be welded using the disclosed welding system 10 and tubular welding wire 50. The illustrated process 60 begins with feeding (block 62) the tubular welding electrode 50 (i.e., the tubular welding wire 50) to a welding apparatus (e.g., welding torch 18). As set forth above, in certain embodiments, the tubular welding wire 50 may include one or more alginate arc stabilizer components (e.g., potassium alginate, calcium alginate, or sodium alginate), silicon, and manganese. Further, the tubular welding wire 50 may have an outer diameter between approximately 0.024 in and approximately 0.062 in, between approximately 0.030 in and approximately 0.060 in, between 0.035 in and approximately 0.052 in, or approximately 0.040 in. It may also be appreciated that, in certain embodiments, the welding system 10 may feed the tubular welding wire 50 at a suitable rate to enable a travel speed greater than 30 in/min or greater than 40 in/min.

Additionally, the process 60 includes providing (block 64) a shielding gas flow (e.g., 100% carbon dioxide, 100% argon, 75% argon/25% carbon dioxide, 90% argon/10% carbon dioxide, 95% argon/5% carbon dioxide, or similar shielding gas flow) near the contact tip of the welding apparatus (e.g., the contact tip of the torch 18). In other embodiments, welding systems may be used that do not use a gas supply system (e.g., such as the gas supply system 16 illustrated in FIG. 1) and one or more components (e.g., potassium carbonate) of the tubular welding wire 50 may decompose to provide a shielding gas component (e.g., carbon dioxide).

Next, the tubular welding wire 50 may be brought near (block 66) the workpiece 22 to strike and sustain an arc 34 between the tubular welding wire 50 and the workpiece 22. It should be appreciated that the arc 34 may be produced using, for example, a DCEP, DCEN, DC variable polarity, pulsed DC, balanced or unbalanced AC power configuration for the GMAW system 10. Once the arc 34 has been established to the workpiece 22, a portion of the tubular welding wire 50 (e.g., filler metals and alloying components) may be transferred (block 68) into the weld pool on the surface of the workpiece 22 to form a weld bead of a weld deposit. Meanwhile, the remainder of the components of the tubular welding wire 50 may be released (block 70) from the tubular welding wire 50 to serve as arc stabilizers, slag formers, or deoxidizers to control the electrical characteristics of the arc and the resulting chemical and mechanical properties of the weld deposit.

FIG. 4 illustrates an embodiment of a process 80 by which the tubular welding wire 50 may be manufactured. It may be appreciated that the process 80 merely provides an example of manufacturing a tubular welding wire 50; however, in other embodiments, other methods of manufacturing may be used to produce the tubular welding wire 50 without spoiling the effect of the present approach. That is, for example, in certain embodiments, the tubular welding wire 50 may be formed via a roll-forming method or via packing the core composition into a hollow metallic sheath. The process 80 illustrated in FIG. 4 begins with a flat metal strip being fed (block 82) through a number of dies that shape the strip into a partially circular metal sheath 52 (e.g., producing a semicircle or trough). After the metal strip has been at least partially shaped into the metal sheath 52, it may be filled (block 84) with the filler (e.g., the granular metal core 54). That is, the partially shaped metal sheath 52 may be filled with various powdered alloying, arc stabilizing, slag forming, deoxidizing, or filling components. For example, among the various fluxing and alloying components, one or more alginate arc stabilizer components (e.g., potassium alginate), one or more carbon components (e.g., graphite powder), and one or more rare earth components (e.g., rare earth silicide) may be added to the metal sheath 52. Furthermore, in certain embodiments, other components (e.g., rare earth silicide, magnetite, titanate, pyrite, iron powders, or other similar components) may also be added to the partially shaped metal sheath 52.

Next in the illustrated process 80, once the components of the granular metal core material 54 have been added to the partially shaped metal sheath 52, the partially shaped metal sheath 52 may then be fed through (block 86) one or more devices (e.g., drawing dies or other suitable closing devices) that may generally close the metal sheath 52 such that it substantially surrounds the granular metal core material 54 (e.g., forming a seam 58). Additionally, the closed metal sheath 52 may subsequently be fed through (block 88) a number of devices (e.g., drawing dies or other suitable devices) to reduce the circumference of the tubular welding wire 50 by compressing the granular metal core material 54. In certain embodiments, the tubular welding wire 50 may subsequently be heated to between approximately 300° F. and approximately 650° F. for approximately 4 to 6 hours prior to packaging the tubular welding wire onto a spool, reel, or drum for transport, while, in other embodiments, the tubular welding wire 50 may be packaged without this baking step.

Some of the elements described herein are identified explicitly as being optional, while other elements are not identified in this way. Even if not identified as such, it will be noted that, in some embodiments, some of these other elements are not intended to be interpreted as being necessary, and would be understood by one skilled in the art as being optional.

While the present disclosure has been described with reference to certain implementations, it will be understood by those skilled in the art that various changes may be made and equivalents may be substituted without departing from the scope of the present method or system. In addition, many modifications may be made to adapt a particular situation or material to the teachings of the present disclosure without departing from its scope. For example, systems, blocks, or other components of disclosed examples may be combined, divided, re-arranged, or otherwise modified. Therefore, the present disclosure is not limited to the particular implementations disclosed. Instead, the present disclosure will include all implementations falling within the scope of the appended claims, both literally and under the doctrine of equivalents.

1. A tubular metal-cored welding electrode comprising:
a metallic sheath disposed around a granular metal core,
wherein the granular metal core comprises by weight of the tubular welding electrode:
0.05 to 5% of an alginate arc stabilizer configured to release hydrogen near a surface of a workpiece during welding,
0.1 to 1% silicon, and
0 to 2.5% manganese.

2. The tubular welding electrode of claim 1, wherein the granular metal core further comprises by weight of the tubular welding electrode 0.5 to 1% nickel.

3. The tubular welding electrode of claim 1, wherein the granular metal core further comprises by weight of the tubular welding electrode 0.05 to 0.15% titanium.

4. The tubular welding electrode of claim 1, wherein the alginate arc stabilizer comprises potassium alginate, calcium alginate, or sodium alginate.

5. The tubular welding electrode of claim 1, wherein the core further comprises one or more metal hydrides.

6. The tubular welding electrode of claim 1, wherein the core further comprises sodium carboxymethylcellulose (CMC), calcium CMC, or potassium CMC.

7. The tubular welding electrode of claim 1, wherein the core comprises 0 to 0.25% manganese.

8. The tubular welding electrode of claim 7, wherein the metallic sheath comprises by weight of the tubular welding electrode:
0 to 0.025% carbon; and
0.05 to 0.4% manganese.

9. The tubular welding electrode of claim 8, wherein the metallic sheath comprises 0.2 to 0.3% manganese.

10. The tubular welding electrode of claim 1, wherein the core comprises 1 to 1.5% manganese.

11. The tubular welding electrode of claim 10, wherein the metallic sheath comprises by weight of the tubular welding electrode:
0 to 0.1% carbon; and
0.05 to 0.4% manganese.

12. The tubular welding electrode of claim 11, wherein the metallic sheath comprises 0.2 to 0.3% manganese.

13. A method for forming a weld, comprising the steps of:
a. providing a tubular welding electrode comprising a metallic sheath and a granular metal core,
wherein the granular metal core comprises by weight of the tubular welding electrode:
0.05 to 5% of an alginate arc stabilizer,
0.1 to 1% silicon, and
0 to 1.5% manganese;
b. feeding the tubular welding electrode to a welding apparatus;
c. feeding a shielding gas flow to the welding apparatus;
d. providing a workpiece;
e. bringing the welding apparatus near the workpiece to strike and sustain an arc between the tubular welding electrode and the workpiece;
f. transferring a portion of the tubular welding electrode to the weld pool on the surface of the workpiece to form a weld bead on the weld deposit; and
g. breaking down in the arc the alginate arc stabilizer to produce hydrogen, which combines with impurities and outgas instead of forming solid slag, oxides, or silicates on the weld surface.

14. The method of claim 12, wherein the granular metal core further comprises by weight of the tubular welding electrode 0.5 to 1% nickel.

15. The method of claim 12, wherein the granular metal core further comprises by weight of the tubular welding electrode 0.05 to 0.15% titanium.

16. The method of claim 13, wherein the alginate arc stabilizer comprises potassium alginate, calcium alginate, or sodium alginate.

17. The method of claim 13, wherein the core further comprises one or more metal hydrides.

18. The method of claim 13, wherein the core further comprises sodium carboxymethylcellulose (CMC), calcium CMC, or potassium CMC.

19. The method of claim 13, wherein the metallic sheath comprises by weight of the tubular welding electrode:
0 to 0.1% carbon; and
0.05 to 0.4% manganese.

20. The method of claim 19, wherein the metallic sheath comprises 0.2 to 0.3% manganese.
